(19) United States
(12) Patent Application Publication
(10) Pub. No.: US 2024/0222921 A1
(43) Pub. Date: Jul. 4, 2024

(54) JOINT TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Hideto NAKAMURA, Mie (JP); Tetsuya MIYAMURA, Mie (JP); Daisuke SAITO, Mie (JP)

(21) Appl. No.: 18/563,315

(22) PCT Filed: May 13, 2022
(86) PCT No.: PCT/JP2022/020176

§ 371 Date: Nov. 21, 2023

(30) Foreign Application Priority Data
Jun. 3, 2021 (JP) 2021-093357

(51) Int. Cl. H01R 31/08; H01R 13/422

(52) U.S. Cl. CPC H01R 31/08; H01R 13/422

(57) ABSTRACT

It is aimed to provide a joint terminal enabling connection while suppressing enlargement. A joint terminal (10) is made of a metal plate material and provided with a base portion (26), a plurality of connecting portions (27) projecting forward from the base portion (26), and a guide portion (38) extending in a front-rear direction while surrounding the plurality of connecting portions (27). A mating connector (90) is fit to the guide portion (38).

### TECHNICAL FIELD

The present disclosure relates to a joint terminal.

### BACKGROUND

Patent Document 1 discloses a joint connector provided with a busbar and a housing. The busbar is a joint terminal made of metal and includes a body portion and a plurality of branched terminal portions projecting forward from the body portion. The housing is made of synthetic resin and includes a connector fitting chamber and a busbar insertion opening. The busbar is inserted into the connector fitting chamber through the busbar insertion opening and accommodated into the housing. Another connector is inserted into the connector fitting chamber of the housing from a side opposite to the busbar insertion opening. A plurality of connection terminals are accommodated in the other connector. Each connection terminal is connected to each branched terminal portion.

### PRIOR ART DOCUMENT

### Patent Document

Patent Document 1: JP 2005-149934 A

### SUMMARY OF THE INVENTION

### Problems to be Solved

In the case of Patent Document 1, in connecting the joint connector and the other connector, the housing is necessary separately from the busbar and there is a problem that the joint connector is enlarged accordingly.

Accordingly, the present disclosure aims to provide a joint terminal enabling connection while suppressing enlargement.

### Means to Solve the Problem

The present disclosure is directed to a joint terminal made of a metal plate material, the joint terminal including a base portion, a plurality of connecting portions projecting forward from the base portion, and a guide portion extending in a front-rear direction while surrounding the plurality of connecting portions.

### Effect of the Invention

According to the present disclosure, it is possible to provide a joint terminal enabling connection while suppressing enlargement.

### BRIEF DESCRIPTION OF THE DRAWINGS

FIG. 1 is a perspective view of a joint terminal of an embodiment.

FIG. 2 is a perspective view showing a state where a female housing is fit to a parallel portion of the joint terminal.

FIG. 3 is a perspective view showing a state where the female housing and a mating connector are respectively fit to the parallel portion and a body portion of the joint terminal.

FIG. 4 is a side view in section showing a state where the mating connector is fit to the body portion of the joint terminal.

FIG. 5 is a side view of the body portion of the joint terminal.

FIG. 6 is a front view of the body portion of the joint terminal.

FIG. 7 is a plan view of the body portion of the joint terminal.

FIG. 8 is a development of the body portion of the joint terminal.

### DETAILED DESCRIPTION TO EXECUTE THE INVENTION

### Description of Embodiments of Present Disclosure

First, embodiments of the present disclosure are listed and described.

(1) The joint terminal of the present disclosure is made of a metal plate material and includes a base portion, a plurality of connecting portions projecting forward from the base portion, and a guide portion extending in a front-rear direction while surrounding the plurality of connecting portions.

Since each connecting portion is surrounded by the guide portion in this joint terminal, a mating connector can be fit to the guide portion and each mating terminal accommodated in the mating connector can be connected to each connecting portion. According to this configuration, a size reduction can be easily realized as compared to the case where each connecting portion is surrounded by a housing.

(2) Preferably, the guide portion integrally includes a first plate portion, a pair of second plate portions rising from both ends of the first plate portion and a third plate portion projecting from one of the pair of second plate portions toward the other.

In this joint terminal, the guide portion can be easily formed by bending the plate material.

(3) The plurality of connecting portions may be coupled to the third plate portion via the base portion having a folded shape.

In this joint terminal, the base portion and each connecting portion can be easily formed by bending the plate material. Further, the lift and inclination of the mating connector can be prevented by arranging the mating connector to face the third plate portion.

(4) The third plate portion may include a fixed lock portion lockable to a mating resilient lock portion.

In this joint terminal, a connected state to the mating connector including the resilient lock portion can be maintained by locking the lock portion to the resilient lock portion. Particularly if the fixed lock portion is made of metal, a resilient force of the resilient lock portion can be stably received.

(5) The joint terminal may be entirely made of the single plate material.

The number of components of this joint terminal is not increased even if a structure in which the plurality of connecting portions are surrounded by the guide portion is adopted.

### Details of Embodiment of Present Disclosure

A specific example of an embodiment of the present disclosure is described below with reference to the drawings. Note that the present invention is not limited to this illustration, but is represented by claims and intended to include all changes in the scope of claims and in the meaning and scope of equivalents.

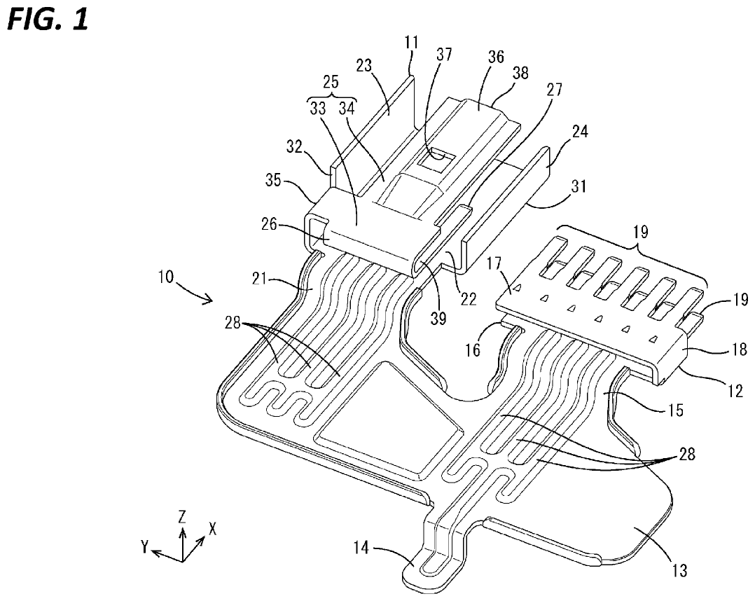

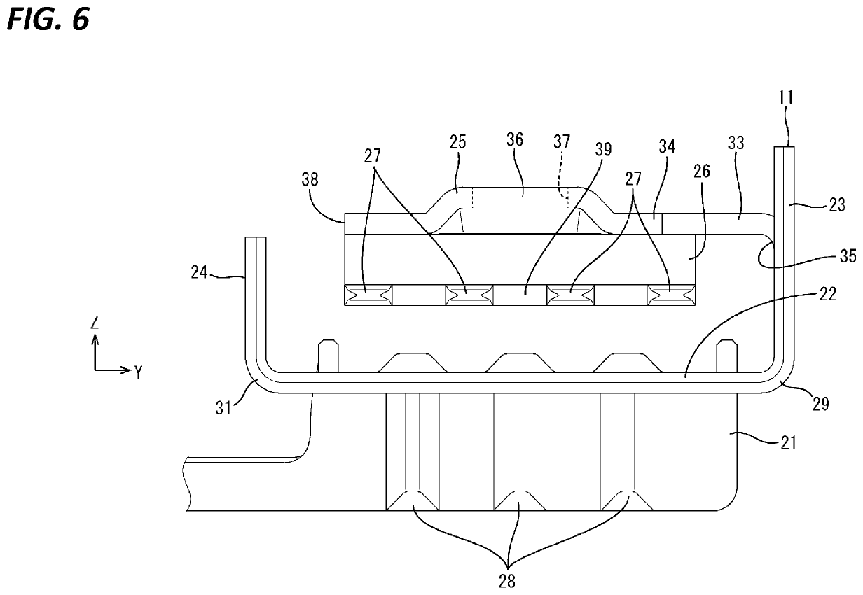

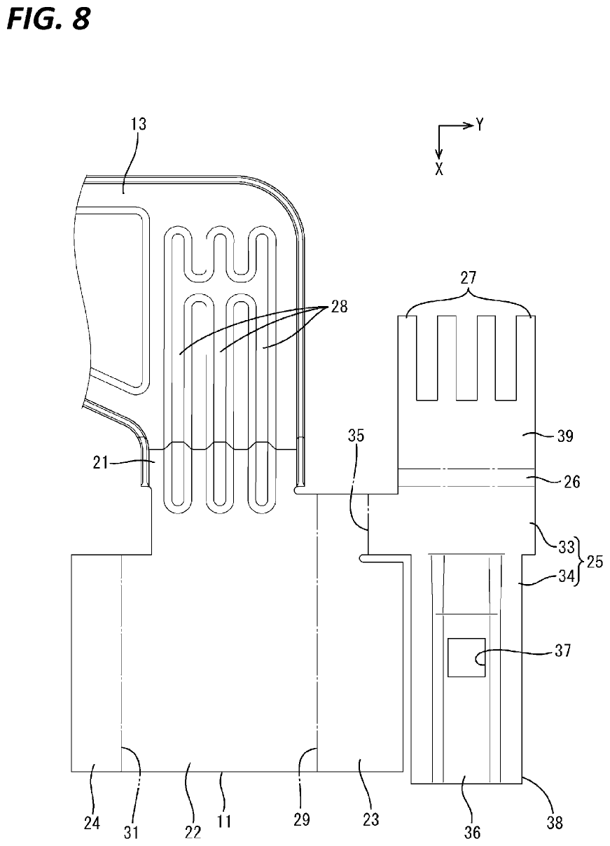

A joint terminal 10 of this embodiment is, for example, used in a branched part of an electrically conductive path in a vehicle. This joint terminal 10 is entirely formed of an electrically conductive metal plate material. Note that, in the following description of the specific structure of the joint terminal 10, a side toward which the joint terminal 10 is facing a mating connector 90 serving as a connection partner is referred to as a front side and an opposite side thereof is referred to as a rear side concerning a front-rear direction X. A vertical direction Z is synonymous with a height direction and based on a vertical direction of FIGS. 1 to 6. A lateral direction Y is synonymous with a width direction and based on a lateral direction of FIGS. 6 and 8. In the case of this embodiment, a right side of FIG. 6 when the joint terminal 10 is viewed from front is referred to as “one side” and a left side of FIG. 6 is referred to as “another side”. These directions are merely defined for the convenience of description and do not limit a mode during use. Further, in the following description, the mating connector 90 may be abbreviated as the connector 90.

As shown in FIG. 1, the joint terminal 10 includes a body portion 11, a parallel portion 12 and a coupling portion 13 coupling the body portion 11 and the parallel portion 12. The body portion 11 and the parallel portion 12 are branched from the coupling portion 13. The coupling portion 13 is in the form of a flat plate and arranged such that the plate surfaces are facing in the vertical direction. The coupling portion 13 is formed with a mounting piece 14 projecting rearward. The mounting piece 14 is fixed to a vehicle body.

The parallel portion 12 is arranged side by side with the body portion 11 in the lateral direction. The parallel portion 12 includes a base end portion 15 rising from the other side of the front edge of the coupling portion 13, a lower plate portion 16 connected to the upper edge of the base end portion 15 and extending in the lateral direction, an upper plate portion 17 facing in parallel to the lower plate portion 16 above the lower plate portion 16 and a side plate portion 18 connecting the other side edges of the respective upper plate portion 17 and lower plate portion 16. Further, the parallel portion 12 includes a plurality of connection pieces 19 projecting forward from each of the upper plate portion 17 and the lower plate portion 16. The respective connection pieces 19 are arranged side by side at certain intervals in the lateral direction on the front edge of each of the upper plate portion 17 and the lower plate portion 16.

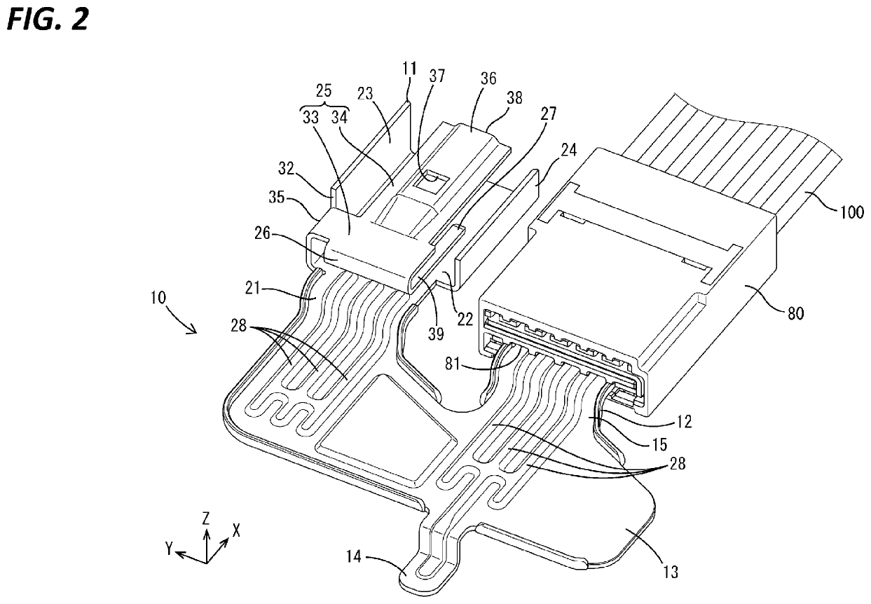

As shown in FIG. 2, a female housing 80 separate from the joint terminal 10 is fit to the parallel portion 12. The female housing 80 is made of synthetic resin and has a flat rectangular appearance. A mounting portion 81 and a plurality of unillustrated terminal accommodating portions are formed to communicate with each other inside the female housing 80. The mounting portion 81 is open in the rear surface of the female housing 80, and each terminal accommodating portion is open in the front surface of the female housing 80. The lower plate portion 16 and the upper plate portion 17 are inserted into the mounting portion 81 of the female housing 80 from behind and retained. Each connection piece 19 is arranged to project into each terminal accommodating portion of the female housing 80. Note that an unillustrated female terminal is inserted into each terminal accommodating portion of the female housing 80 from front and accommodated. Each connection piece 19 is connected to each female terminal. Each female terminal is connected to an end part of a wire 100.

The body portion 11 integrally includes a base end portion 21 rising from the one side of the front edge of the coupling portion 13, a first plate portion 22 extending forward from the upper edge of the base end portion 21, second plate portions 23, 24 on the one and the other sides respectively rising from both left and right edges of the first plate portion 22, and a third plate portion 25 projecting from the second plate portion 23 on the one side toward the second plate portion 24 on the other side. Further, the body portion 11 integrally includes a base portion 26 projecting downward from the rear edge of the third plate portion 25 and a plurality of connecting portions 27 projecting forward from the front-lower edge of the base portion 26. Similarly to the base end portion 15, the base end portion 21 has a shape wide in the lateral direction and is arranged such that the plate surfaces thereof are facing in the front-rear direction.

The first plate portion 22 is in the form of a flat plate along the lateral direction and arranged such that the plate surfaces thereof are facing in the vertical direction. The first plate portion 22 is arranged to be higher than the coupling portion 13 via the base end portion 21. Note that the joint terminal 10 is formed such that a plurality of ridge portions 28 extend in a part from one side part of the coupling portion 13 to a rear end part of the first plate portion 22 via the base end portion 21 and a part from the other side part of the coupling portion 13 to a rear end part of the lower plate portion 16 via the base end portion 15.

As shown in FIG. 6, the second plate portion 23 on the one side is coupled to one side edge of the first plate portion 22 to perpendicularly rise via a bent portion 29. The second plate portion 23 on the one side is in the form of a flat plate along the vertical direction and arranged such that the plate surfaces thereof are facing in the lateral direction.

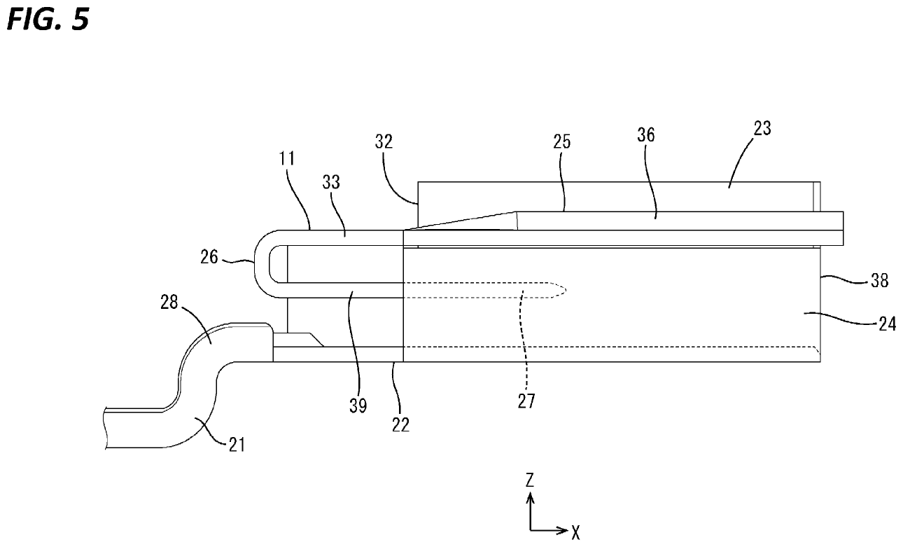

As shown in FIGS. 1 and 5, a step 32 along the vertical direction is formed on the upper edge of the second plate portion 23 on the one side. Out of the upper edge of the second plate portion 23 on the one side, a rear upper edge located on a rear side via the step 32 is arranged to be lower than a front upper edge located on a front side.

As shown in FIG. 6, the second plate portion 24 on the other side is coupled to the other side edge of the first plate portion 22 except a rear part to perpendicularly rise via a bent portion 31. Similarly to the second plate portion 23 on the one side, the second plate portion 24 on the other side is in the form of a flat plate and arranged such that the plate surfaces thereof are facing in the lateral direction. As shown in FIGS. 1 and 5, the second plate portion 24 on the other side is formed to be shorter than the second plate portion 23 on the one side in the front-rear direction. The upper edge of the second plate portion 24 on the other side is arranged along the front-rear direction and at a position lower than the front upper edge of the second plate portion 23 on the one side.

As shown in FIG. 1, the third plate portion 25 includes a coupling end portion 33 extending toward the other side from a bent edge 35 serving as the rear upper edge of the second plate portion 23 on the one side, and a covering portion 34 projecting forward from the coupling end portion 33. The other side edge of the coupling end portion 33 is arranged away from the second plate portion 24 on the other side toward the one side in the lateral direction. Further, the coupling end portion 33 and the second plate portion 24 on the other side are shifted in position in the front-rear direction. As shown in FIG. 6, the upper surface of the coupling end portion 33 is arranged at a position higher than the upper edge of the second plate portion 24 on the other side by a thickness of the coupling end portion 33.

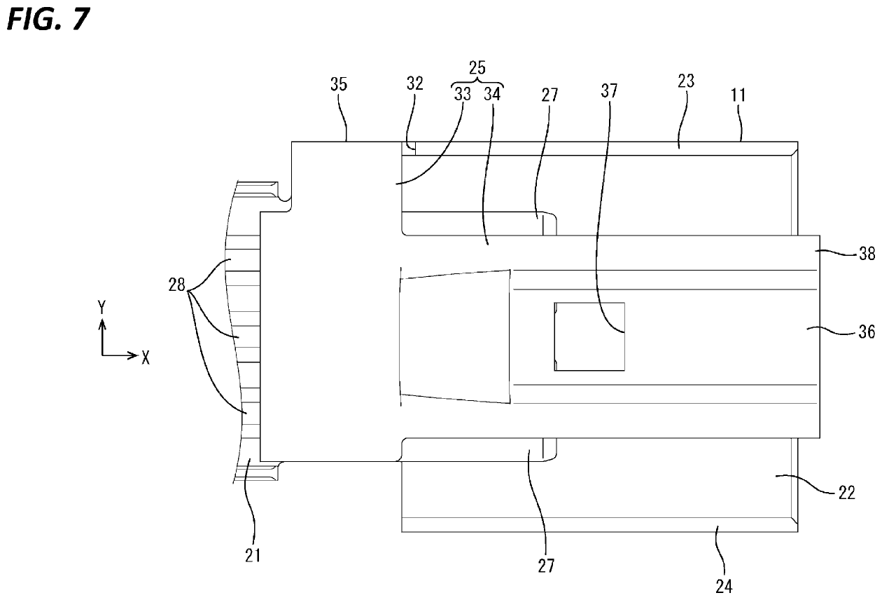

As shown in FIG. 7, the covering portion 34 is in the form of a flat plate, extends forward from a lateral intermediate part of the coupling end portion 33 and is arranged such that the plate surfaces thereof are facing in the vertical direction. The covering portion 34 and the first plate portion 22 are arranged in parallel while being spaced apart in the vertical direction.

The covering portion 34 includes a lock portion 36 bent to bulge upward in a lateral intermediate part. As shown in FIG. 6, the lock portion 36 has a trapezoidal shape in a front view and includes a lock hole 37 penetrating in the vertical direction in an upper wall part along the lateral direction. As shown in FIG. 1, the lock hole 37 is an opening rectangular in a plan view and formed in the upper wall part of the lock portion 36.

The first, second and third plate portions 22, 23, 24 and 25 are configured as a guide portion 38 capable of guiding the mating connector 90. The guide portion 38 is in the form of a receptacle having a rectangular cross-section as a whole although a gap is present between the other side edge of the coupling end portion 33 and the second plate portion 24 on the other side.

As shown in FIG. 5, the base portion 26 is folded to have a U-shaped cross-section while being curved rearward from a front-upper edge connected to the third plate portion 25 to a front-lower edge connected to the respective connecting portions 27. The base portion 26 includes a flat plate portion 39 connected to the rear edge of the coupling end portion 33 except an end part on the one side and facing in parallel to the coupling end portion 33 below the coupling end portion 33. The respective connecting portions 27 are tab-like and project forward from the front edge of the flat plate portion 39 while being arranged side by side at certain intervals in the lateral direction on the front edge of the flat plate portion 39 of the base portion 26 as shown in FIG. 6.

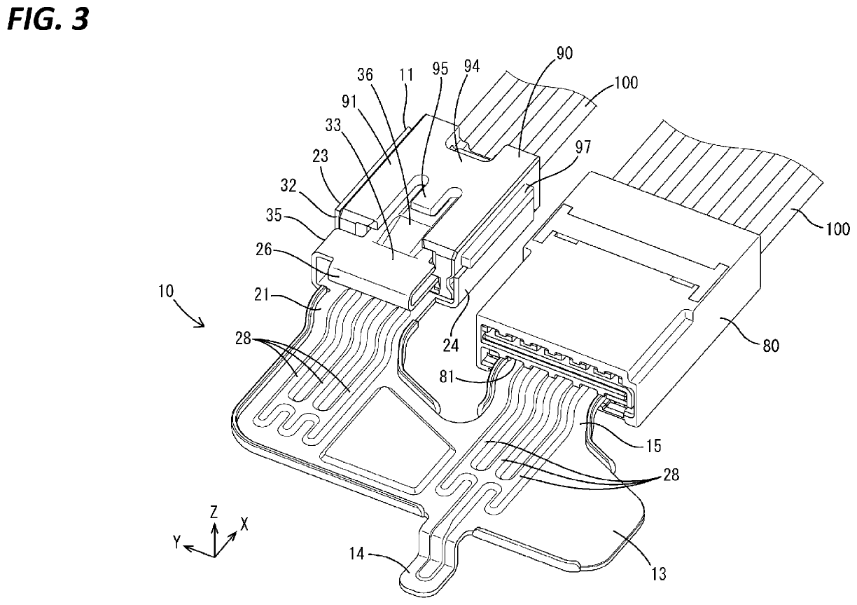

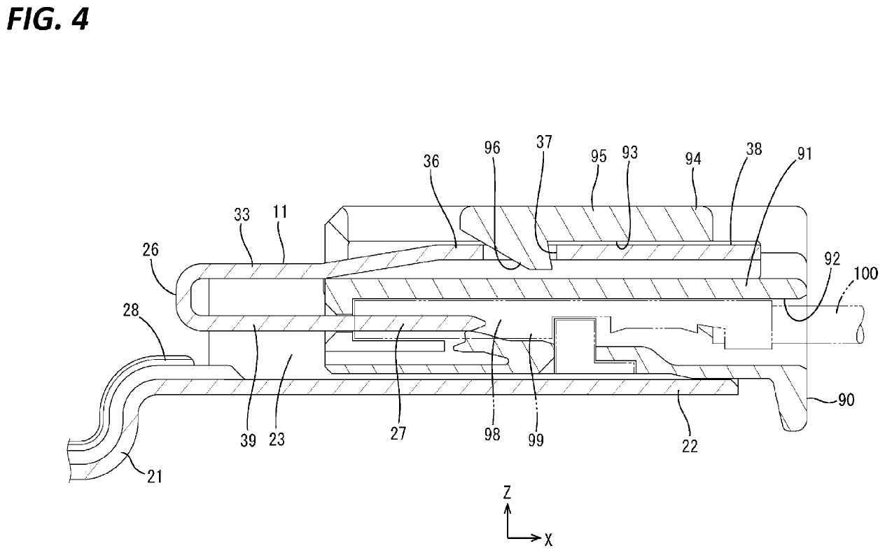

As shown in FIG. 4, the mating connector 90 is provided with a mating housing 91 and mating terminals 99. The mating housing 91 is made of synthetic resin and has a flat rectangular appearance. The mating housing 91 is formed with a plurality of cavities 92 capable of accommodating the mating terminals 99. Further, the mating housing 91 includes a lock space portion 93 penetrating in the front-rear direction, a beam portion 94 bridged in the lateral direction above the lock space portion 93 and a resilient lock portion 95 projecting rearward from the beam portion 94 in upper wall parts of the respective cavities 92. The resilient lock portion 95 is deflectable and deformable in the vertical direction with a coupled part to the beam portion 94 as a fulcrum. A claw-like lock projection 96 projecting toward the lock space portion 93 is formed on a tip part of the resilient lock portion 95. As shown in FIG. 3, the mating housing 91 is formed with a rib 97 extending long in the front-rear direction on a side surface corresponding to the second plate portion 24 on the other side. The mating terminal 99 is a female terminal made of electrically conductive metal and includes a tubular box portion 98. The corresponding connecting portion 27 is inserted and connected to the box portion 98. The mating terminal 99 is connected to an end part of a wire 100.

Next, a manufacturing method and an assembling method of the joint terminal 10 of this embodiment are described.

The joint terminal 10 is formed by bending a singe plate material in a developed state shown in FIG. 8. In forming the body portion 11, a part corresponding to the base portion 26 is bent to form the third plate portion 25 and each connecting portion 27 and, then, successively bent at the body portions 29, 31 and the bent edge 35, whereby the guide portion 38 composed of the first, second and third plate portions 22, 23, 24 and 25 is formed into a receptacle shape.

As shown in FIG. 2, the female housing 80 is fit to the parallel portion 12 in advance. Each connection piece 19 is surrounded by the female housing 80. In contrast, each connecting portion 27 is arranged inside the guide portion 38 and surrounded by the first, second and third plate portions 22, 23, 24 and 25.

Subsequently, as shown in FIG. 3, the mating connector 90 is fit to the guide portion 38 of the body portion 11 from front. Here, the mating terminals 99 are accommodated in the mating housing 91 in advance. In a connection process of the connector 90, the mating housing 91 has a movement in the lateral direction restricted by contacting the second plate portion 23, 24 on the one or other side. Further, the mating housing 91 has a downward movement restricted by contacting the first plate portion 22, and has an upward movement restricted by contacting the third plate portion 25. In this way, a connecting operation of the connector 90 is guided by the guide portion 38.

The rib 97 of the mating housing 91 is arranged to contact along the upper edge of the second plate portion 24 on the other side. If the connector 90 is in a fitting posture opposite to the proper one, the rib 97 butts against the front edge of the second plate portion 23 on the one side and the connecting operation of the connector 90 is stopped. Thus, it is possible to avoid a situation where the connector 90 is inserted in a wrong fitting posture into the guide portion 38.

Further, when the connector 90 is inserted into the guide portion 38, the third plate portion 25 is also inserted and fit into the lock space portion 93 of the mating housing 91. In an insertion process of the connector 90, the lock projection 96 slides on the upper surface of the upper wall part of the lock portion 36 and the resilient lock portion 95 is deflected and deformed. When the insertion of the connector 90 is completed, the resilient lock portion 95 resiliently returns and, as shown in FIG. 4, the lock projection 96 is fit into the lock hole 37. In this way, the connector 90 is held fit in the guide portion 38. If the connector 90 is properly fit into the guide portion 38, each mating terminal 99 is electrically connected to each connecting portion 27 to be short-circuited.

Here, a structure in which the body portion 11 and the parallel portion 12 include a common base end part connected to the coupling portion 13 unlike this embodiment is assumed. In that case, there is a concern that a vibration force of each wire 100 pulled out from the connector 90 and the female housing 80 is directly transferred to the common base end part and stress concentrates on the base end part. In that respect, in the case of this embodiment, the body portion 11 and the parallel portion 12 are individually coupled to the coupling portion 13 via the respective corresponding base end portions 21, 15. Thus, the joint terminal 10 of this embodiment is excellent in installation stability.

As described above, since the mating connector 90 is fit to the guide portion 38 of the joint terminal 10 and each mating terminal 99 is connected to each connecting portion 27 according to this embodiment, a housing for surrounding each connecting portion 27 becomes unnecessary and the structure on the side of the body portion 11 including the guide portion 38 can be reduced in size. Further, since the guide portion 38 integrally includes the first, second and third plate portions 22, 23, 24 and 25, the guide portion 38 can be easily formed by bending. Since the entire joint terminal 10 is made of the single plate material, the number of components is not increased even if a structure of surrounding the plurality of connecting portions 27 by the guide portion 38 is adopted.

Further, since the third plate portion 25 is inserted into the lock space portion 93 of the mating housing 91 and an upper wall part of the mating housing 91 is arranged to face the third plate portion 25, the lift and inclination of the connector 90 can be prevented. Furthermore, since the resilient lock portion 95 is locked to the fixed lock portion 36 formed on the third plate portion 25, a resilient force of the resilient lock portion 95 is stably received by the lock portion 36.

### Other Embodiments of Present Disclosure

The embodiment disclosed this time should be considered illustrative in all aspects, rather than restrictive.

In the case of the above embodiment, the guide portion is formed into a receptacle shape as a whole by the first, second and third plate portions. However, as another embodiment, the guide portion only has to be shaped to be able to guide the mating connector. For example, one of the respective second plate portions may be omitted.

In the case of the above embodiment, the joint terminal is structured such that the body portion and the parallel portion are branched from the coupling portion. However, as another embodiment, the joint terminal may be structured not to include the parallel portion.

In the case of the above embodiment, the lock portion is integrally provided on the third plate portion. However, as another embodiment, the lock portion may be provided separately from the third plate portion or in another part of the third plate portion.

In the case of the above embodiment, the entire joint terminal is made of a single plate material. However, as another embodiment, the joint terminal may be constituted by combining two or more members. For example, a member including the respective connecting portions and a member including the guide portion may be separately provided.

### LIST OF REFERENCE NUMERALS

10 . . . joint terminal
11 . . . body portion
12 . . . parallel portion
13 . . . coupling portion
14 . . . mounting piece
15 . . . base end portion
16 . . . lower plate portion
17 . . . upper plate portion
18 . . . side plate portion
19 . . . connection piece
21 . . . base end portion
22 . . . first plate portion
23 . . . second plate portion on one side
24 . . . second plate portion on other side
25 . . . third plate portion
26 . . . base portion
27 . . . connecting portion
28 . . . ridge portion
29, 31 . . . bent portion
32 . . . step
33 . . . coupling end portion
34 . . . covering portion
35 . . . bent edge
36 . . . lock portion
37 . . . lock hole
38 . . . guide portion
39 . . . flat plate portion
80 . . . female housing
81 . . . mounting portion
90 . . . mating connector (connector)
91 . . . mating housing
92 cavity
93 lock space portion
94 beam portion
95 . . . resilient lock portion
96 . . . lock projection
97 . . . rib
98 . . . box portion
99 . . . mating terminal
100 . . . wire

1. A joint terminal made of a metal plate material, comprising:
a base portion;
a plurality of connecting portions projecting forward from the base portion; and
a guide portion extending in a front-rear direction while surrounding the plurality of connecting portions.

2. The joint terminal of claim 1, wherein the guide portion integrally includes a first plate portion, a pair of second plate portions rising from both ends of the first plate portion and a third plate portion projecting from one of the pair of second plate portions toward the other.

3. The joint terminal of claim 2, wherein the plurality of connecting portions are coupled to the third plate portion via the base portion having a folded shape.

4. The joint terminal of claim 2, wherein the third plate portion includes a fixed lock portion lockable to a mating resilient lock portion.

5. The joint terminal of claim 1, wherein the joint terminal is entirely made of the single plate material.
